(19) United States
(12) Patent Application Publication
(10) Pub. No.: US 2022/0371543 A1
(43) Pub. Date: Nov. 24, 2022

(54) CONTROL DEVICE AND STORAGE MEDIUM

(71) Applicant: KABUSHIKI KAISHA TOKAI RIKA DENKI SEISAKUSHO, Aichi (JP)

(72) Inventor: Yosuke Ohashi, Aichi (JP)

(73) Assignee: KABUSHIKI KAISHA TOKAI RIKA DENKI SEISAKUSHO, Aichi (JP)

(21) Appl. No.: 17/704,245

(22) Filed: Mar. 25, 2022

(30) Foreign Application Priority Data
May 19, 2021 (JP) 2021-084346

(51) Int. Cl. B60R 25/01; H04W 4/02; B60R 25/10; B60R 25/34

(52) U.S. Cl. CPC B60R 25/01; H04W 4/023; B60R 25/1001; B60R 25/34; H04W 12/06

(57) ABSTRACT

The present invention provides technique capable of reducing the number of devices mounted on a moving object.

Provided is a control device including a communication control unit that controls transmission of a first signal from a communication device, the first signal being used in a first measurement method among a plurality of measurement methods of measuring a distance between an object and the communication device as a distance measurement value, wherein the communication control unit controls transmission of a second signal from the communication device, the second signal being used in a second measurement method different from the first measurement method among the plurality of measurement methods, on the basis of a change in a position of a first object present outside a cabin of a moving object on which the communication device is mounted being detected according to the first measurement method.

### CROSS REFERENCE TO RELATED APPLICATION(S)

This application is based upon and claims benefit of priority from Japanese Patent Application No. 2021-084346, filed on May 19, 2021, the entire contents of which are incorporated herein by reference.

### BACKGROUND

The present invention relates to a communication device and a storage medium.

In recent years, a technique for measuring a distance between an object and a device mounted on a moving object has become known. For example, there is a technique for measuring a distance between a communication device and a terminal on the basis of the propagation time of electric waves transmitted and received between the communication device and the terminal used by a user (refer to, for example, U.S. Pat. No. 9,566,945). In such a technique, an operation of a vehicle is permitted in a case where a position of the terminal detected on the basis of the distance between the communication device and the terminal satisfies conditions.

### SUMMARY

However, a plurality of measurement methods may be used as a measurement method of measuring a distance between a device and an object as a distance measurement value. In this case, if a device required for measurement is mounted on a moving object for each measurement method, there is a problem that the number of devices mounted on the moving object cannot be reduced.

Therefore, the present invention has been made in view of the above problem, and an object of the present invention is to provide a technique capable of reducing the number of devices mounted on a moving object.

To solve the above-described problems, according to an aspect of the present invention, there is provided a control device includes a communication control unit that controls transmission of a first signal from a communication device, the first signal being used in a first measurement method among a plurality of measurement methods of measuring a distance between an object and the communication device as a distance measurement value. The communication control unit may control transmission of a second signal from the communication device, the second signal being used in a second measurement method different from the first measurement method among the plurality of measurement methods, on the basis of a change in a position of a first object present outside a cabin of a moving object on which the communication device is mounted being detected according to the first measurement method.

In addition, to solve the above-described problems, according to another aspect of the present invention, there is provided a non-transitory computer readable storage medium storing a program causing a computer to function as a control device including a communication control unit that controls transmission of a first signal from a communication device, the first signal being used in a first measurement method among a plurality of measurement methods of measuring a distance between an object and the communication device as a distance measurement value. The communication control unit may control transmission of a second signal from the communication device, the second signal being used in a second measurement method different from the first measurement method among the plurality of measurement methods, on the basis of a change in a position of a first object present outside a cabin of a moving object on which the communication device is mounted being detected according to the first measurement method.

In addition, to solve the above-described problems, according to another aspect of the present invention, there is provided a control device includes a state acquisition unit that acquires a state of a moving object and a communication control unit that controls, on the basis of the state of the moving object, which one of a first signal and a second signal is to be transmitted from a communication device, the first signal being used in a first measurement method among a plurality of measurement methods of measuring a distance between an object and the communication device as a distance measurement value, and the second signal being used in a second measurement method different from the first measurement method among the plurality of measurement methods.

As described above, according to the present invention, there is provided a technique capable of reducing the number of devices mounted on a moving object.

### BRIEF DESCRIPTION OF THE DRAWINGS

FIG. 1 is a diagram for describing an example of a first measurement method of measuring a distance between a device and an object.

FIG. 2 is a diagram for describing an example of a second measurement method of measuring a distance between a device and an object.

FIG. 3 is a diagram illustrating a configuration example of a communication system according to an embodiment of the present invention.

FIG. 4 is a diagram illustrating an example of transition in an operation mode of a vehicle according to an embodiment of the present invention.

FIG. 5 is a diagram for describing an object detection mode.

FIG. 6 is a diagram for describing a notification mode.

FIG. 7 is a diagram for describing a combination mode.

FIG. 8 is a diagram for describing a terminal position detection mode.

### DETAILED DESCRIPTION OF THE EMBODIMENT

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 0. Background

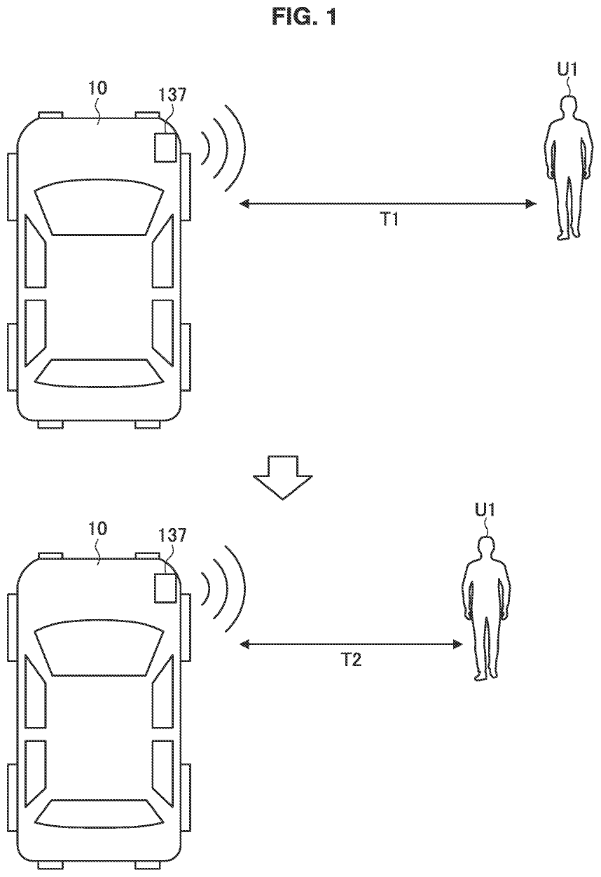

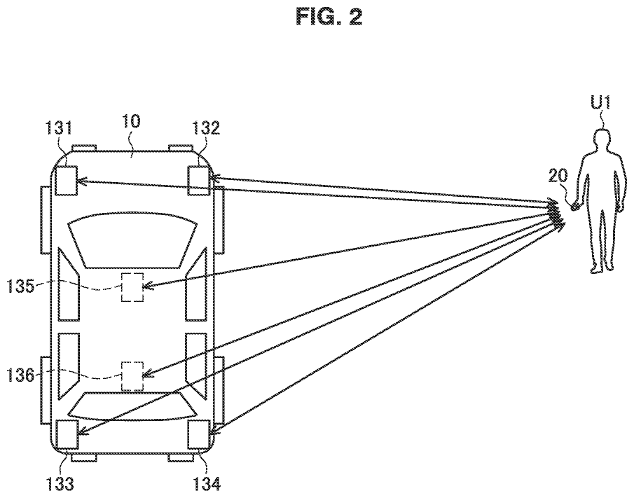

First, the background of the embodiment of the present invention will be described. In recent years, a technique for measuring a distance between a communication device mounted on a moving object and an object has been known. However, a plurality of measurement methods may be used as a measurement method of measuring a distance between a communication device and an object as a distance measurement value. First, a first measurement method and a second measurement method will be described as examples of a plurality of measurement methods with reference to FIGS. 1 and 2.

FIG. 1 is a diagram for describing an example of a first measurement method of measuring a distance between a device and an object. Referring to FIG. 1, a vehicle 10 is illustrated as an example of a moving object, and a user U1 of a terminal correlated with the vehicle 10 is illustrated as an example of an object. The vehicle 10 is equipped with a sensor 137 as an example of a mounted device. Here, as an example of the first measurement method, a method of measuring a distance between the sensor 137 and the user U1 will be described.

The sensor 137 transmits a pulse signal. The pulse signal is a signal based on a wave (pulse wave) that is repeatedly output intermittently. In a case where the pulse signal is used, the propagation time of the pulse signal corresponding to a difference between the transmission time of the pulse signal by the sensor 137 and the reception time of a reflected signal of the pulse signal from the user U1 by the sensor 137 can be easily measured. A distance between the sensor 137 and the user U1 is obtained on the basis of the propagation time of the pulse signal.

More specifically, as illustrated in the upper part of FIG. 1, the propagation time of the pulse signal, which is the time from when the pulse signal is transmitted by the sensor 137 to when the reflected signal of the pulse signal from the user U1 is received by the sensor 137, is time T1. Thereafter, it is assumed that the user U1 moves toward the vehicle 10.

In such a case, as illustrated in the lower part of FIG. 1, it is assumed that the propagation time of the pulse signal, which is the time from when the pulse signal is transmitted by the sensor 137 to when the reflected signal of the pulse signal from the user U1 is received by the sensor 137, changes to time T2. The vehicle 10 can detect movement of the user U1 on the basis of a change in the propagation time of the pulse signal. As an example, the vehicle 10 can detect that the user U1 has approached the vehicle 10 on the basis of a reduction in the propagation time of the pulse signal.

In the example illustrated in FIG. 1, a case where a distance between the sensor 137 and the user U1 is measured is illustrated. However, in the first measurement method, it is possible to generally measure a distance between the sensor 137 and any object. Therefore, the first measurement method can be used to measure a distance between the sensor 137 and any of various objects not limited to the user U1 of the terminal.

FIG. 2 is a diagram illustrating an example of the second measurement method of measuring a distance between a device and an object. Referring to FIG. 2, a vehicle 10 is illustrated as an example of a moving object, and a terminal 20 held by a user U1 is illustrated as an example of an object. In the same manner as in FIG. 1, the vehicle 10 is equipped with communication devices 131 to 136 as an example of mounted devices. Here, as an example of the second measurement method, a method of measuring a distance between each of the communication devices 131 to 136 and the terminal 20 will be described.

One of the communication device 131 and the terminal 20 transmits a first distance measurement signal for measuring a distance between the communication device 131 and the terminal 20. When the first distance measurement signal is received, the other transmits a second distance measurement signal which is a response to the first distance measurement signal. One of them receives the second distance measurement signal. In this case, the propagation time of the first distance measurement signal and the second distance measurement signal can be easily measured. A distance between the communication device 131 and the terminal 20 is obtained on the basis of the propagation time.

A distance between each of the communication devices 132 to 136 and the terminal 20 can be measured in the same manner as the distance between the communication device 131 and the terminal 20.

As an example, a position of the terminal 20 can be estimated by using any three of the distances between the communication devices 131 to 136 and the terminal 20. For example, the accuracy of estimating a position of the terminal 20 is improved by using three selected in order from the smallest distance for estimating a position of the terminal 20.

It may be assumed that a distance between the communication device 131 and the terminal 20 is measured a plurality of times. In such a case, the minimum value of distances obtained through a plurality of measurements may be used for estimating a position of the terminal 20. Consequently, it is possible to reduce a probability that a distance measured to be longer than an actual distance due to a distance measurement signal reflected by an obstacle or the like will be used for estimating a position of the terminal 20.

Unlike the first measurement method, the second measurement method may be used to measure a distance between the terminal 20 correlated with the vehicle 10 and each of the communication devices 131 to 136 with high accuracy. Unlike the first measurement method, the second measurement method may also be used to estimate a position of the terminal 20 on the basis of a measured distance.

As described with reference to FIGS. 1 and 2, a plurality of measurement methods may be used as a measurement method of measuring a distance between a device and an object. In this case, if a device required for measurement is mounted on the vehicle 10 for each measurement method, the number of devices mounted on the vehicle 10 cannot be reduced.

For example, it can be assumed that the cost incurred for the mounted devices is not reduced because the number of mounted devices on the vehicle 10 is not reduced. If the number of devices mounted on the vehicle 10 is not reduced, a space occupied by the mounted devices may increase, and thus it may be difficult to mount devices on the vehicle 10.

Therefore, in the embodiment of the present invention, a technique capable of reducing the number of devices mounted on a moving object is mainly proposed. According to such a technique, it can be expected that the cost incurred for mounted devices will be reduced. According to such a technique, it can be expected that a device will be easily mounted on a moving object.

### 1. Embodiment

Hereinafter, a communication system according to an embodiment of the present invention will be described.

### 1.1. Configuration Example

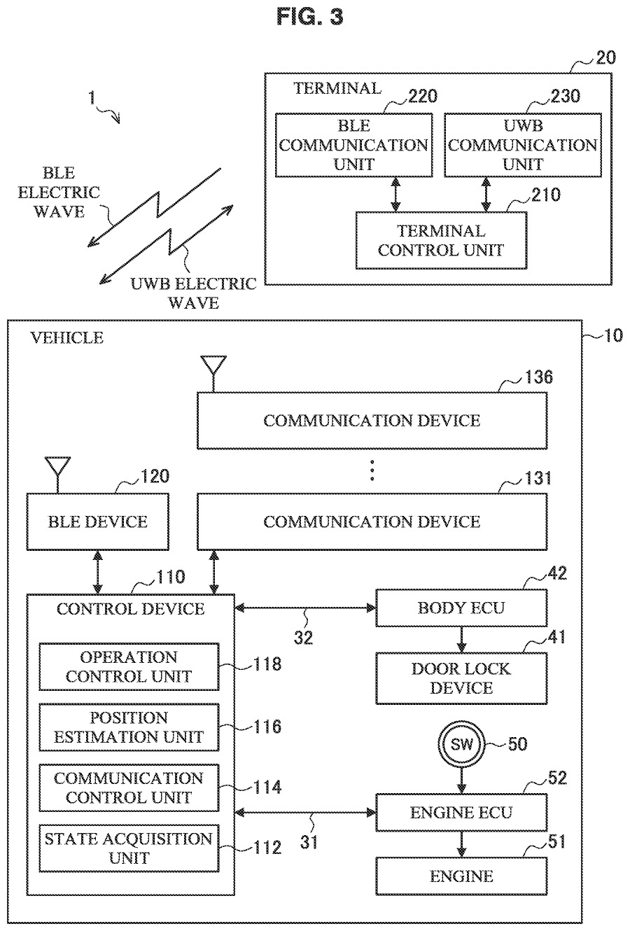

First, a configuration example of a communication system according to the embodiment of the present invention will be described with reference to FIG. 3.

FIG. 3 is a diagram illustrating a configuration example of a communication system according to the embodiment of the present invention. As illustrated in FIG. 3, a communication system 1 according to the embodiment of the present invention includes a vehicle 10 and a terminal 20. The terminal 20 may correspond to an approved communication partner of the vehicle 10.

The vehicle 10 is just an example of a moving object. Therefore, any of other moving objects (for example, ships and aircrafts) may be used instead of the vehicle 10. In the embodiment of the present invention, it is mainly assumed that the terminal 20 is an electronic key. However, the terminal 20 may be a terminal other than an electronic key, a smartphone, a tablet terminal, a mobile phone, or another electronic device.

(Configuration of Vehicle 10)

Next, a configuration of the vehicle 10 will be described. As illustrated in FIG. 1, the vehicle 10 includes a door lock device 41 as an example of an in-vehicle device, a body electronic control unit (ECU) 42, an engine 51 as an example of an in-vehicle device, an engine ECU 52, a control device 110, a Bluetooth (registered trademark) Low Energy (BLE) device 120, and communication devices 131 to 136.

The door lock device 41 controls locking and unlocking of a door of the vehicle 10. The body ECU 42 manages the power supply of the in-vehicle electrical components. For example, the body ECU 42 drives the door lock device 41 under the control of the control device 110. For example, a computer functions as the body ECU 42 by a processor executing a program corresponding to the body ECU 42 recorded on a recording medium (not illustrated).

The engine 51 is an engine of the vehicle 10. The engine ECU 52 controls the engine 51. For example, the engine ECU 52 drives the engine 51 under the control of the control device 110. For example, the computer functions as the engine ECU 52 by executing a program corresponding to the engine ECU 52 recorded on a recording medium (not illustrated) by the processor.

The control device 110 includes a state acquisition unit 112, a communication control unit 114, a position estimation unit 116, and an operation control unit 118. The state acquisition unit 112, the communication control unit 114, the position estimation unit 116, and the operation control unit 118 will be described later in detail. For example, the computer functions as the control device 110 by the processor executing a program corresponding to the control device 110 recorded on a recording medium (not illustrated). As an example, the control device 110 may correspond to a collation ECU that controls locking and unlocking of the door.

The communication device 131 is mounted on the vehicle 10 and functions as an example of a device that measures a distance between the communication device 131 and an object. In the embodiment of the present invention, it is mainly assumed that an electric wave used by the communication device 131 (such as a pulse signal or an electric wave used for a first distance measurement signal and a second distance measurement signal, which will be described in detail later) is an electric wave in the ultra wide band (UWB). Consequently, a distance between the communication device 131 and an object can be measured with high accuracy. However, an electric wave used by the communication device 131 is not limited to an electric wave in the UWB.

In the embodiment of the present invention, a plurality of measurement methods are used as a method of measuring a distance between the communication device 131 and an object. Hereinafter, a case where the above first measurement method and second measurement method are used as the plurality of measurement methods will be described.

For example, the computer functions as the communication device 131 by the processor executing a program corresponding to the communication device 131 recorded on a recording medium (not illustrated). The communication devices 132 to 136 also have the same function as that of the communication device 131. The number of communication devices mounted on the vehicle 10 is not limited to six. For example, the number of communication devices mounted on the vehicle 10 may be a plural number other than six, or may be one.

The BLE device 120 performs communication based on the BLE standard with the terminal 20. The BLE device 120 is an example of a communication device that communicates with the terminal 20 by transmitting and receiving electric waves to and from the terminal 20. Therefore, instead of the BLE device 120, a communication device other than the BLE device 120 may be used. For example, instead of the BLE device 120, a communication device that performs communication based on the Near Field Communication (NFC) standard may be used.

The control device 110 and the body ECU 42 are connected to each other via a communication line 32 inside the vehicle 10. A protocol used for communication via the communication line 32 may be, for example, Controller Area Network (CAN) or Local Interconnect Network (LIN). The control device 110 and the engine ECU 52 are connected to each other via a communication line 31 inside the vehicle 10. A protocol used for communication via the communication line 31 may be, for example, CAN or LIN.

(Configuration of Terminal 20)

Next, a configuration of the terminal 20 will be described. The terminal 20 includes a terminal control unit 210, a BLE communication unit 220, and a UWB communication unit 230.

The terminal control unit 210 controls an operation of the terminal 20. For example, the computer functions as the terminal control unit 210 by the processor executing a program corresponding to the terminal control unit 210 recorded on a recording medium (not illustrated). As an example, the terminal control unit 210 controls communication by the BLE communication unit 220 and communication by the UWB communication unit 230.

The BLE communication unit 220 performs communication based on the BLE standard with the vehicle 10. The BLE communication unit 220 is an example of a communication device that communicates with the vehicle 10 by transmitting and receiving electric waves to and from the vehicle 10. Therefore, instead of the BLE communication unit 220, a communication unit other than the BLE communication unit 220 may be used. For example, instead of the BLE communication unit 220, another communication unit of which a communication method has been changed according to a change in a communication method of the communication device included in the vehicle 10 may be used.

The UWB communication unit 230 executes communication with each of the communication devices 131 to 136 mounted on the vehicle 10. In the embodiment of the present invention, it is mainly assumed that an electric wave used by the UWB communication unit 230 (such as an electric wave used for the first distance measurement signal and the second distance measurement signal that will be described later in detail) is an electric wave in the UWB. As a result, a distance between each of the communication devices 131 to 136 and the terminal 20 can be measured with high accuracy. However, instead of the UWB communication unit 230, another communication unit of which a communication method has been changed according to the change in the communication method of the communication devices 131 to 136 may be used.

A configuration example of the communication system according to the embodiment of the present invention has been described above with reference to FIG. 3.

### 1.2. Operation Example of Present Embodiment

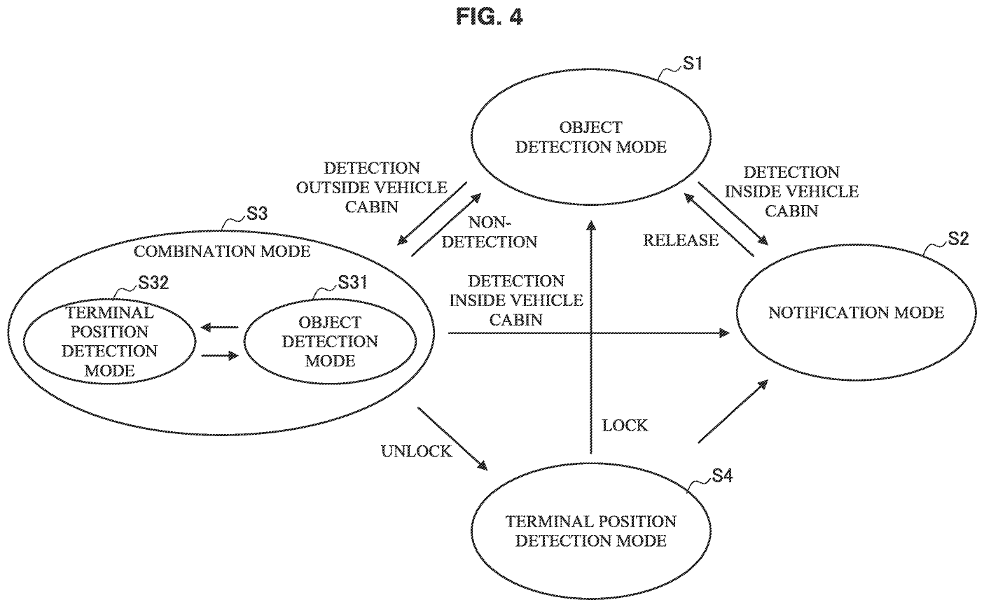

Subsequently, an operation example of the communication system 1 according to the embodiment of the present invention will be described with reference to FIGS. 4 to 8.

FIG. 4 is a diagram illustrating an example of transition in an operation mode of the vehicle 10 according to the embodiment of the present invention. As illustrated in FIG. 4, as an example of an operation mode of the vehicle 10, there is an object detection mode S1 of measuring a distance between the communication device and an object according to the above first measurement method. As an example of the operation mode of the vehicle 10, there is a terminal position detection mode S4 of measuring a distance between the communication device and the terminal according to the above second measurement method.

As an example of the operation mode of the vehicle 10, there is a combination mode S3 in which an object detection mode S31 similar to the object detection mode S1 and a terminal position detection mode S32 similar to the terminal position detection mode S4 are used in combination. As an example of the operation mode of the vehicle 10, there is a notification mode S2 of providing a notification.

Before the start of the engine of the vehicle 10 is permitted, the state acquisition unit 112 acquires a state of the vehicle 10. More specifically, the state acquisition unit 112 acquires whether the door of the vehicle 10 is in a locked state or an unlocked state as an example of the state of the vehicle 10. The locked state of the door is an example of a first state of the vehicle 10. The unlocked state of the door is an example of a second state of the vehicle 10.

In a case where a state of the vehicle 10 acquired by the state acquisition unit 112 is the locked state of the door, the communication control unit 114 sets an operation mode to the object detection mode S1 on the basis of the state of the vehicle 10 being the locked state of the door. On the other hand, in a case where the state of the vehicle 10 acquired by the state acquisition unit 112 is the unlocked state of the door, the communication control unit 114 sets an operation mode to the terminal position detection mode S4 on the basis of the state of the vehicle 10 being the unlocked state of the door. The vehicle 10 operates according to the set operation mode.

(Object Detection Mode S1)

The object detection mode S1 is an operation mode in which a distance between an object and the communication device is measured according to the first measurement method. More specifically, in the object detection mode S1, the communication control unit 114 controls transmission of a pulse signal from the communication devices 131 to 135, the pulse signal being used in the first measurement method. For example, the pulse signal may be periodically and repeatedly transmitted. The pulse signal is an example of a first signal.

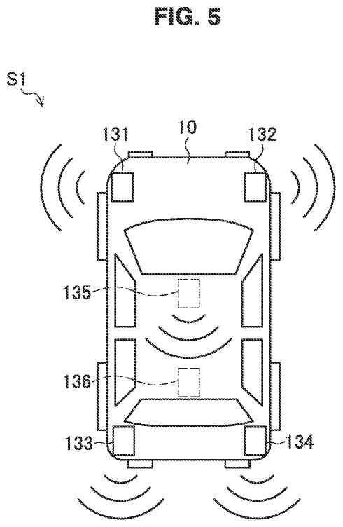

FIG. 5 is a diagram for describing the object detection mode S1. Referring to FIG. 5, the communication devices 131 to 134 are provided outside a cabin of the vehicle 10, and in the object detection mode S1, the communication devices 131 to 134 transmit pulse signals outward of the cabin of the vehicle 10. A change in a position of an object present outside the cabin of the vehicle 10 (that is, outside the vehicle cabin) can be detected by the pulse signals directed outward of the cabin of the vehicle 10.

On the other hand, the communication devices 135 and 136 are provided in the cabin of the vehicle 10, and in the object detection mode S1, the communication device 135 transmits a pulse signal toward the cabin of the vehicle 10. A change in a position of an object present in the cabin of the vehicle 10 (that is, inside the vehicle cabin) can be detected by the pulse signal directed toward the cabin of the vehicle 10. The communication device 136 may also transmit the pulse signal toward the cabin of the vehicle 10 in the same manner as the communication device 135, but in the example illustrated in FIG. 5, the pulse signal is not transmitted.

A change in a position of an object may be detected as follows as an example. Although the description will be made assuming that the pulse signal is transmitted by the communication device 131, the change in the position of the object can be detected in the same manner for a case where the pulse signal is transmitted by another communication device. That is, the communication control unit 114 measures a distance measurement value on the basis of the time from when the pulse signal is transmitted by the communication device 131 to when the pulse signal is reflected by an object (first object) and received by the communication device 131 (that is, the propagation time of the pulse signal).

Here, the distance measurement value may be a value based on the propagation time of the pulse signal. For example, the distance measurement value may be the propagation time of the pulse signal (round-trip time), may be a half of the propagation time of the pulse signal (one-way time), or a one-way distance obtained by multiplying a signal speed by the one-way time.

The communication control unit 114 detects a change in a position of the object (first object) on the basis of a change in the distance measurement value. As an example, the communication control unit 114 may detect that the object has moved away from the communication device 131 on the basis of a decrease in the distance measurement value. On the other hand, the communication control unit 114 may detect that the object has approached the communication device 131 on the basis of an increase in the distance measurement value.

Here, a case is assumed in which, even though the terminal 20 of which authentication is successful is not present in the cabin of the vehicle 10, a change in a position of an object (second object) is detected on the basis of the propagation time of the pulse signal transmitted by the communication device 135 provided in the cabin of the vehicle 10 (“detection in vehicle cabin” in FIG. 4). The fact that the terminal 20 of which authentication is successful is not present in the cabin of the vehicle 10 may mean that the door is not unlocked (that is, the terminal position detection mode S4 has not transitioned to the object detection mode S1).

In such a case, it is probable that an unjust person (that is, an intruder) has moved in the vehicle cabin. Therefore, the communication control unit 114 may cause the operation mode to transition to the notification mode S2 on the basis of the detection of the change in the position of the object in the vehicle cabin. Details of the notification mode S2 will be described later.

On the other hand, a case is assumed in which a change in a position of an object (first object) is detected on the basis of the propagation time of a pulse signal transmitted by at least one of the communication devices 131 to 134 provided outside the cabin of the vehicle 10 (“detection outside vehicle cabin” in FIG. 4).

In such a case, there is a probability that a user is trying to get on the vehicle 10 outside the vehicle cabin. Therefore, the communication control unit 114 may cause the operation mode to transition to the combination mode S3 on the basis of the detection of the change in the position of the object outside the vehicle cabin. For example, the communication control unit 114 may cause the operation mode to transition to the combination mode S3 on the basis of it being detected that the object is approaching at least one of the communication devices 131 to 134 outside the vehicle cabin. Details of the combination mode S3 will be described later.

(Notification Mode S2)

The notification mode S2 is an operation mode of outputting predetermined warning information. More specifically, in the notification mode S2, the communication control unit 114 controls outputting of predetermined warning information. The outputting of the predetermined warning information may be voice output of the warning information to the surroundings, or may be provision of a notification of the warning information to a terminal of an owner of the vehicle 10. In a case where any release operation is performed by the owner (“release” in FIG. 4), the operation mode may transition from the notification mode S2 to the object detection mode S1.

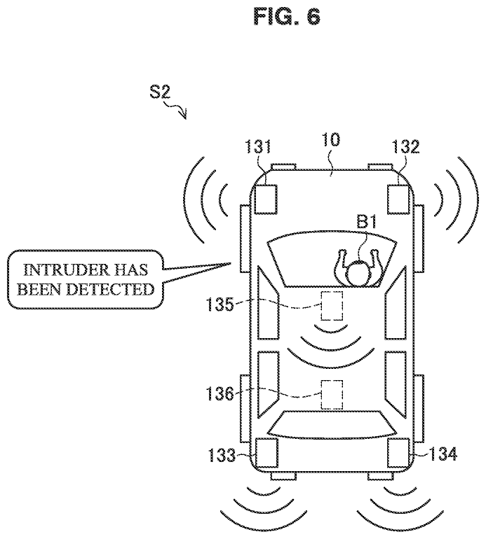

FIG. 6 is a diagram for describing the notification mode S2. Referring to FIG. 6, an intruder B1 has invaded the vehicle 10. The communication control unit 114 controls outputting of warning information in a case where a change in a position of the intruder B1 is detected on the basis of the propagation time of the pulse signal transmitted by the communication device 135 provided in the cabin of the vehicle 10. In the example illustrated in FIG. 6, warning information such as “an intruder has been detected” is illustrated as an example, but the warning information is not limited to such an example.

(Combination Mode S3)

The combination mode S3 is a mode in which the object detection mode S31 and the terminal position detection mode S32 are alternately executed. In a case where a state of the vehicle 10 transitions to an unlocked state of the door in the terminal position detection mode S32 (“unlock” in FIG. 4), the communication control unit 114 may cause the operation mode to transition to the terminal position detection mode S4. On the other hand, in a case where a change in a position of the object is no longer detected outside the cabin of the vehicle 10 (“non-detection” in FIG. 4), the communication control unit 114 may cause the operation mode to transition from the combination mode S3 to the object detection mode S1.

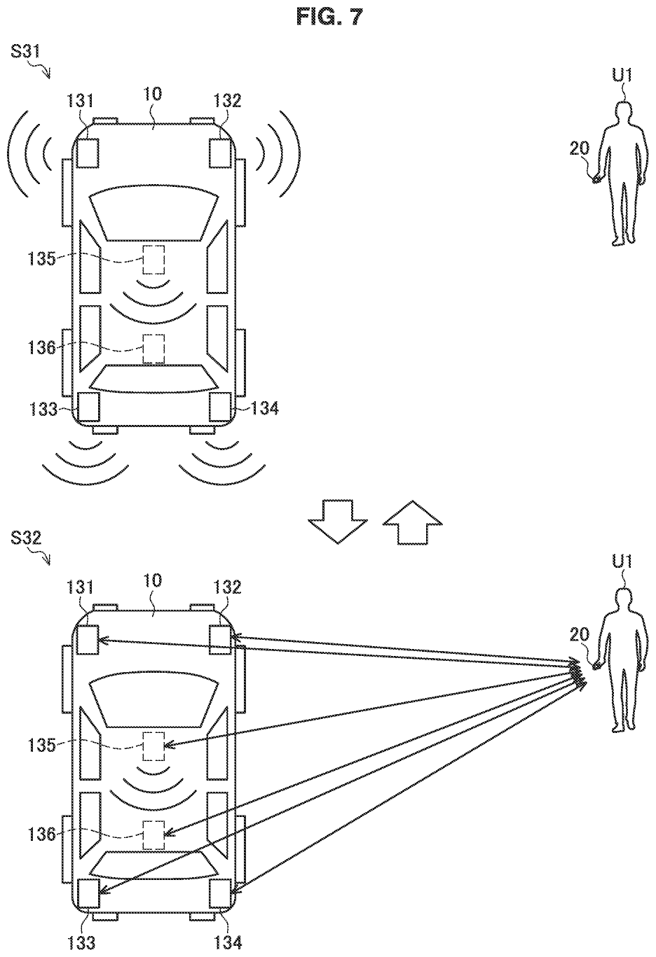

FIG. 7 is a diagram for describing the combination mode S3. As illustrated in FIG. 7, in the combination mode S3, the object detection mode S31 and the terminal position detection mode S32 are alternately executed. Here, the object detection mode S31 is an operation mode similar to the object detection mode S1. Thus, detailed description of the object detection mode S31 will be omitted. On the other hand, the terminal position detection mode S32 is an operation mode similar to the terminal position detection mode S4.

In the combination mode S3, it is possible to deal with a case where an unjust person intrudes the vehicle 10 according to the object detection mode S31 and a case where a legitimate user tries to get on the vehicle 10 according to the terminal position detection mode S32. Hereinafter, the terminal position detection mode S32 will be described.

(Terminal Position Detection Mode S32)

The terminal position detection mode S32 is an operation mode of measuring a distance between an object and the communication device according to the second measurement method. More specifically, in the terminal position detection mode S32, the communication control unit 114 controls transmission of a signal from the communication devices 131 to 136, the signal being used in the second measurement method. For example, the signal used in the second measurement method is different from a pulse signal that is periodically and repeatedly transmitted. The signal used in the second measurement method is an example of a second signal.

In the terminal position detection mode S32, the communication control unit 114 authenticates the terminal 20 on the basis of authentication information transmitted from the BLE communication unit 220 of the terminal 20 and received by the BLE device 120 of the vehicle 10. The communication control unit 114 controls transmission of a signal (second signal) from the communication devices 131 to 136 for measuring a distance between the terminal 20 and each of the communication devices 131 to 136 on the basis of successful authentication of the terminal 20.

Here, the signal transmitted from the communication devices 131 to 136 to the terminal 20 may be a first distance measurement signal used for measuring a distance between the communication devices 131 to 136 and the terminal 20 or a second distance measurement signal that is a response to the first distance measurement signal. The communication control unit 114 measures a distance between each of the communication devices 131 to 136 and the terminal 20 as a distance measurement value on the basis of the propagation time of the first distance measurement signal and the second distance measurement signal between the communication devices 131 to 136 and the terminal 20.

As an example, a case is assumed in which the communication device 131 transmits the first distance measurement signal, and the terminal 20 transmits the second distance measurement signal that is a response to the first distance measurement signal. In such a case, the communication control unit 114 may calculate, as the propagation time of the first distance measurement signal and the second distance measurement signal, a time obtained by subtracting a time ΔT2 from a reception time point of the first distance measurement signal to a transmission period of time of the second distance measurement signal in the terminal 20 from a time ΔT1 from a transmission time point of the first distance measurement signal to a reception point time of the second distance measurement signal in the communication device 131.

Although the description has been made assuming that the communication device 131 transmits the first distance measurement signal, the propagation time of the first distance measurement signal and the second distance measurement signal can be calculated in the same manner for a case where the first distance measurement signal is transmitted by the terminal 20. Although the description has been made assuming that the signal is transmitted by the communication device 131, the propagation time of the first distance measurement signal and the second distance measurement signal can be calculated in the same manner for a case where the signal is transmitted by another communication device.

Here, the distance measurement value may be a value based on the propagation time of the first distance measurement signal and the second distance measurement signal. For example, the distance measurement value may be the propagation time of the first distance measurement signal and the second distance measurement signal (round-trip time), may be a half the propagation time of the first distance measurement signal and the second distance measurement signal (one-way time), or a one-way distance obtained by multiplying a signal speed by the one-way time.

The position estimation unit 116 estimates a position of the terminal 20 on the basis of the distance measurement value between each of the communication devices 131 to 136 and the terminal 20. As an example, the position estimation unit 116 may estimate the position of the terminal 20 by using any three of the distance measurement values. For example, the position estimation unit 116 improves the accuracy of estimating a position of the terminal 20 by using three selected in order from the smallest distance measurement value for estimating the position of the terminal 20.

It may be assumed that a distance measurement value between each of the communication devices 131 to 136 and the terminal 20 is measured a plurality of times. In such a case, the minimum value of distance measurement values obtained through the plurality of measurements may be used for estimating a position of the terminal 20. Consequently, it is possible to reduce a probability that a distance value measured to be longer than an actual distance due to a distance measurement signal reflected by an obstacle or the like will be used for estimating a position of the terminal 20.

The operation control unit 118 controls execution of a process corresponding to the position of the terminal 20 estimated by the position estimation unit 116. As an example, the operation control unit 118 controls an operation of the vehicle 10 on the basis of the position of the terminal 20 estimated by the position estimation unit 116 being within a predetermined area. Consequently, an operation of the vehicle 10 is controlled according to a position of the terminal 20, and thus a user's convenience is improved.

More specifically, in a case where it is determined that the position of the terminal 20 estimated by the position estimation unit 116 is within a predetermined area (for example, in a case where it is determined that the position is outside the vehicle cabin), the operation control unit 118 may permit the body ECU 42 to perform an unlocking operation of the door lock device 41. Consequently, for example, in a case where a door handle on an outer surface of the vehicle is touch-operated in a state in which the door is locked, the door of the vehicle 10 is unlocked.

(Terminal Position Detection Mode S4)

The terminal position detection mode S4 is an operation mode similar to the terminal position detection mode S32. The communication control unit 114 maintains transmission of the first distance measurement signal or the second distance measurement signal from the communication devices 131 to 136 and stops transmission of the pulse signal from the communication devices 131 to 135 on the basis of transition in the operation mode to the terminal position detection mode S4.

Also in the terminal position detection mode S4, a position of the terminal 20 is estimated by the position estimation unit 116 in the same manner as in the terminal position detection mode S32. The operation control unit 118 controls execution of a process corresponding to a position of the terminal 20 estimated by the position estimation unit 116. As an example, the operation control unit 118 controls an operation of the vehicle 10 on the basis of a position of the terminal 20 estimated by the position estimation unit 116. Consequently, an operation of the vehicle 10 is controlled according to a position of the terminal 20, and thus a user's convenience is improved.

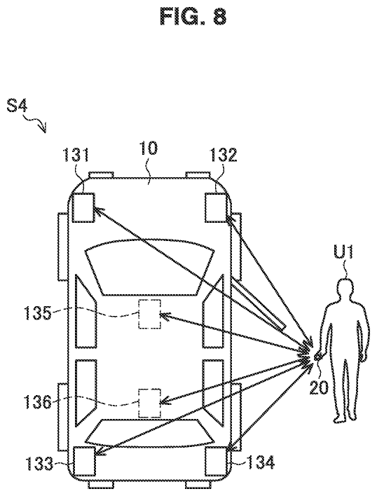

FIG. 8 is a diagram for describing the terminal position detection mode S4. In the example illustrated in FIG. 8, a state of the vehicle 10 is an unlocked state of the door. In such a state, it is assumed that a position of the terminal 20 estimated by the position estimation unit 116 is determined as being outside the vehicle cabin. In such a case, the operation control unit 118 may permit the body ECU 42 to perform a locking operation of the door lock device 41. Consequently, for example, in a case where a lock button of the door handle on the outer surface of the vehicle is pressed in a state in which the door is unlocked, the vehicle door is locked.

As another example, the operation control unit 118 may permit the engine of the vehicle 10 to be started in a case where it is determined that the position of the terminal 20 estimated by the position estimation unit 116 is in the vehicle cabin.

Consequently, for example, in a case where the engine switch 50 is operated while a brake pedal is depressed, the engine 51 is started. More specifically, in a case where it is determined that the position of the terminal 20 estimated by the position estimation unit 116 is in the vehicle cabin, the operation control unit 118 may permit a transition operation of the vehicle power supply using the engine switch 50 in the vehicle cabin.

A target of operation control by the operation control unit 118 is not limited to a machine or a device of the vehicle 10. The operation control unit 118 may control an operation of a machine or device other than the vehicle 10 on the basis of a position of the terminal 20 estimated by the position estimation unit 116.

In a case where a state of the vehicle 10 changes from an unlocked state of the door to a locked state (“lock” in FIG. 4), the communication control unit 114 causes the operation mode to transition to the object detection mode S1. In this case, the communication control unit 114 starts transmission of the pulse signal from the communication devices 131 to 135, and stops transmission of the first distance measurement signal or the second distance measurement signal from the communication devices 131 to 136.

The operation example of the communication system 1 according to the embodiment of the present invention has been described above with reference to FIGS. 4 to 8.

### 1.3. Effect

According to the above embodiment, there is provided the control device 110 including the communication control unit 114 that controls transmission of a first signal from a communication device, the first signal being used in a first measurement method among a plurality of measurement methods of measuring a distance between an object and the communication device as a distance measurement value, and the communication control unit 114 controls transmission of a second signal from the communication device, the second signal being used in a second measurement method different from the first measurement method among the plurality of measurement methods on the basis of a change in a position of a first object present outside a cabin of a moving object on which the communication device is mounted being detected according to the first measurement method.

According to such a configuration, since the first distance measurement method and the second distance measurement method are realized by a common communication device, it is possible to reduce the number of devices mounted on a moving object. According to such a configuration, it can be expected that the cost incurred for mounted device will be reduced. According to such a technique, it can be expected that a device will be easily mounted on a moving object.

According to the above embodiment, there is provided the control device 110 including the state acquisition unit 112 that acquires a state of a moving object, and the communication control unit 114 that controls, on the basis of the state of the moving object, which one of a first signal and a second signal is to be transmitted from a communication device, the first signal being used in a first measurement method among a plurality of measurement methods of measuring a distance between an object and the communication device as a distance measurement value, and the second signal being used in a second measurement method different from the first measurement method among the plurality of measurement methods.

According to such a configuration, since the first distance measurement method and the second distance measurement method are realized by a common communication device, it is possible to reduce the number of devices mounted on a moving object. According to such a configuration, it can be expected that the cost incurred for mounted device will be reduced. According to such a technique, it can be expected that a device will be easily mounted on a moving object.

For example, the communication control unit 114 may control transmission of the first signal from the communication device on the basis of the state of the moving object being a first state. The communication control unit 114 may switch a signal that is a transmission target from the first signal to the second signal on the basis of transition in the state of the moving object from a first state to a second state.

### 1.4. Modification Example

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A control device comprising:
a communication control unit that controls transmission of a first signal from a communication device, the first signal being used in a first measurement method among a plurality of measurement methods of measuring a distance between an object and the communication device as a distance measurement value, wherein
the communication control unit controls transmission of a second signal from the communication device, the second signal being used in a second measurement method different from the first measurement method among the plurality of measurement methods, on the basis of a change in a position of a first object present outside a cabin of a moving object on which the communication device is mounted being detected according to the first measurement method.

2. The control device according to claim 1, wherein
the communication control unit alternately controls the transmission of the first signal and the transmission of the second signal from the communication device on the basis of the change in the position of the first object present outside the cabin of the moving object being detected according to the first measurement method.

3. The control device according to claim 1, further comprising:
a state acquisition unit that acquires a state of the moving object, wherein
the communication control unit controls the transmission of the first signal from the communication device on the basis of the state of the moving object being a first state.

4. The control device according to claim 3, wherein
the communication control unit maintains the transmission of the second signal and stops the transmission of the first signal on the basis of transition in the state of the moving object from the first state to a second state.

5. The control device according to claim 4, wherein
the communication control unit starts the transmission of the first signal and stops the transmission of the second signal on the basis of transition in the state of the moving object from the second state to the first state.

6. The control device according to claim 3, wherein
the first state is a locked state of a door of the moving object.

7. The control device according to claim 4, wherein
the second state is an unlocked state of a door of the moving object.

8. The control device according to claim 1, wherein
the communication control unit measures the distance measurement value on the basis of a time from when the first signal is transmitted from the communication device to when the first signal is reflected by the first object and received by the communication device, and detects the change in the position of the first object on the basis of a change in the distance measurement value.

9. The control device according to claim 1, wherein
the second signal is a first distance measurement signal used for measuring a distance between the communication device and a terminal, or a second distance measurement signal that is a response to the first distance measurement signal, and
the communication control unit measures the distance measurement value on the basis of a propagation time of the first distance measurement signal and the second distance measurement signal between the communication device and the terminal.

10. The control device according to claim 9, further comprising:
an operation control unit that controls a door of the moving object to be unlocked on the basis of it being determined that a position of the terminal based on the distance measurement value is within a predetermined area.

11. The control device according to of claim 1, wherein
the communication control unit controls the transmission of the second signal to the terminal on the basis of successful authentication of the terminal.

12. The control device according to of claim 1, wherein
the communication control unit controls outputting of predetermined warning information on the basis of a change in a position of a second object present in the cabin of the moving object being detected according to the first measurement method even though a terminal of which authentication is successful is not present inside the moving object.

13. A non-transitory computer readable storage medium storing a program causing a computer to function as:
a control device including a communication control unit that controls transmission of a first signal from a communication device, the first signal being used in a first measurement method among a plurality of measurement methods of measuring a distance between an object and the communication device as a distance measurement value, wherein
the communication control unit controls transmission of a second signal from the communication device, the second signal being used in a second measurement method different from the first measurement method among the plurality of measurement methods, on the basis of a change in a position of a first object present outside a cabin of a moving object on which the communication device is mounted being detected according to the first measurement method.

14. A control device comprising:
a state acquisition unit that acquires a state of a moving object; and
a communication control unit that controls, on the basis of the state of the moving object, which one of a first signal and a second signal is to be transmitted from a communication device, the first signal being used in a first measurement method among a plurality of measurement methods of measuring a distance between an object and the communication device as a distance measurement value, and the second signal being used in a second measurement method different from the first measurement method among the plurality of measurement methods.

15. The control device according to claim 14, wherein
the communication control unit controls transmission of the first signal from the communication device on the basis of the state of the moving object being a first state.

16. The control device according to claim 15, wherein
the communication control unit switches a signal that is a transmission target from the first signal to the second signal on the basis of transition in the state of the moving object from the first state to a second state.
